(19) United States
(12) Patent Application Publication
(10) Pub. No.: US 2024/0021913 A1
(43) Pub. Date: Jan. 18, 2024

(54) COOLING MODULE FOR AN ELECTRIC OR HYBRID MOTOR VEHICLE, HAVING A TANGENTIAL-FLOW TURBOMACHINE WITH AN ADDITIONAL HEAT EXCHANGER

(71) Applicant: VALEO SYSTEMES THERMIQUES, La Verriere (FR)

(72) Inventors: Amrid MAMMERI, La Verriere (FR); Kamel AZZOUZ, La Verriere (FR); Gael DURBECQ, La Verriere (FR); Erwan ETIENNE, La Verriere (FR)

(73) Assignee: VALEO SYSTEMES THERMIQUES, La Verriere (FR)

(21) Appl. No.: 18/251,458

(22) PCT Filed: Sep. 30, 2021
(86) PCT No.: PCT/EP2021/076991

§ 371 Date: May 2, 2023

(30) Foreign Application Priority Data
Nov. 4, 2020 (FR) FR2011329

(51) Int. Cl. H01M 10/6563; H01M 10/613; H01M 10/625

(52) U.S. Cl. CPC H01M 10/6563; H01M 10/613; H01M 10/625; F01D 15/00

(57) ABSTRACT

The invention relates to a cooling module for a motor vehicle with an electric or hybrid motor, including: at least one heat exchanger; at least one tangential-flow turbomachine having an axis of rotation, the at least one tangential-flow turbomachine being capable of creating an air flow circulating between an intake opening and a discharge opening, passing through the at least one heat exchanger; at least one housing configured to house the at least one heat exchanger and said at least one tangential-flow turbomachine, the intake opening and the discharge opening being part of the at least one housing; and an additional heat exchanger through which the air flow is intended to pass, arranged outside the at least one housing, downstream of the discharge opening of the cooling module in a longitudinal direction of the cooling module.

### TECHNICAL FIELD

The present invention relates to a cooling module for an electric or hybrid motor vehicle, having a tangential-flow turbomachine.

### BACKGROUND OF THE INVENTION

A cooling module (or heat exchange module) of a motor vehicle conventionally comprises at least one heat exchanger and a ventilation device suitable for generating an air flow passing through the heat exchanger or exchangers. The ventilation device thus makes it possible, for example, to generate an air flow in contact with the heat exchanger, when the vehicle is stationary or running at low speed. This ventilation device for example takes the form of a tangential-flow turbomachine. The air flow enters the enclosure of the cooling module via an intake opening and is discharged via a discharge opening.

Conventionally, the heat exchanger is positioned facing at least two cooling openings formed in the front end of the body of the motor vehicle. A first cooling opening is situated above the fender, while a second opening is situated below the fender. Such a configuration is preferred since the combustion engine must also be supplied with air, the air intake of the engine conventionally being located in the passage of the air flow passing through the upper cooling opening.

However, electric vehicles are preferably only provided with cooling openings situated below the fender, even more preferably with a single cooling opening situated below the fender. This is because the electric motor does not need an air supply. Furthermore, the reduction in the number of cooling openings allows the aerodynamic characteristics of the electric vehicle to be improved. This also results in better range and a higher top speed of the motor vehicle.

However, it means that the space available for arranging the cooling module therein is reduced. The space devoted to the heat exchangers is therefore limited and consequently the total surface for heat exchange is also reduced. This leads to a decrease in the capacity for heat exchange in the cooling module and therefore lower efficiency as regards, for example, air conditioning circuits or thermal management of batteries and other elements.

There is therefore a need to prioritize a compact design of the cooling module and to optimize the architecture of the thermal management circuits or circuits within which the at least one heat exchanger arranged within the cooling module operate(s).

### SUMMARY OF THE INVENTION

One aim of the invention is to propose a cooling module for an electric motor vehicle allowing a better arrangement of the components within the available space.

To this end, the invention relates to a cooling module for a motor vehicle with an electric or hybrid motor, the cooling module comprising at least one heat exchanger, at least one tangential-flow turbomachine having an axis of rotation, the tangential-flow turbomachine being capable of creating an air flow circulating between an intake opening and a discharge opening, passing through the at least one heat exchanger, the cooling module further comprising at least one housing configured to house the at least one heat exchanger and said at least one tangential-flow turbomachine, the cooling module further comprising an additional heat exchanger through which the air flow is intended to pass, arranged outside the at least one housing, downstream of the discharge opening of the cooling module in a longitudinal direction of the cooling module.

Such a cooling module makes it possible to optimize the available space while ensuring heat exchange between the air flow discharged through the discharge opening and the additional heat exchanger. Placing the additional heat exchanger outside the housing makes it possible to make use of a dead volume potentially present facing the discharge opening, which also makes it possible to limit the bulk of the cooling module.

Furthermore, this compact arrangement can lead to greater freedom in terms of the architecture of the cooling module.

The invention can further comprise one or more of the following aspects taken alone or in combination:
the additional heat exchanger is arranged in a cooling circuit comprising, in the direction of circulation of a refrigerant intended to circulate within this cooling circuit: a compressor, a condenser, a first expansion valve and a first evaporator, the additional heat exchanger being arranged in said cooling circuit downstream of the compressor and upstream of the condenser;
the first evaporator of the cooling circuit is a thermal management interface configured to exchange heat with the batteries of the motor vehicle;
the cooling circuit comprises a second expansion valve and a second evaporator arranged in parallel with the first expansion valve and the first evaporator, the second evaporator being intended to have an internal air flow passing through it;
the additional heat exchanger has a parallelepiped shape comprising a length, a height and a width;
the length of the additional heat exchanger is less than or equal to the width of the cooling module;
the cooling module comprises at least one additional wall connecting an edge of the discharge opening to a side of the additional heat exchanger;
the additional wall is a part attached to the edge of the discharge opening;
the width of the additional heat exchanger is less than or equal to a spacing between the additional wall and a lower edge of the cooling module;
the additional heat exchanger is positioned in a general plane parallel to the longitudinal direction of the cooling module; and
the additional heat exchanger is positioned in a general plane parallel to the plane of the discharge opening.

### BRIEF DESCRIPTION OF DRAWINGS

Further advantages and features of the invention will become more clearly apparent from reading the following description, provided by way of illustrative and non-limiting example, and the appended drawings, in which:

FIG. 1 schematically shows the front part of a motor vehicle with an electric or hybrid motor, seen from the side;

FIG. 2 shows a partially cross-sectional perspective view of a front end of a motor vehicle comprising a cooling module;

FIG. 3 shows a cross-sectional view of the cooling module in FIG. 2;

FIG. 4 shows a perspective view of the additional heat exchanger;

FIG. 5 shows a schematic depiction of a thermal management circuit within which the additional heat exchanger is arranged; and

FIG. 6 shows a schematic depiction of a variant of the thermal management circuit of FIG. 5.

### DETAILED DESCRIPTION OF THE INVENTION

In these figures, identical elements have the same reference numbers.

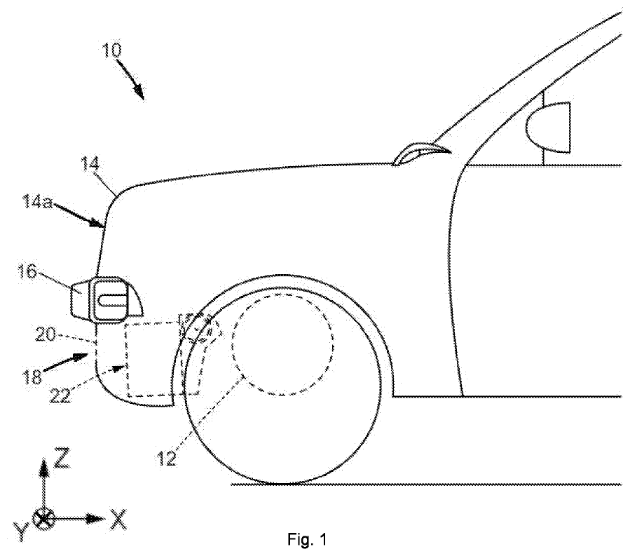

In FIGS. 1 to 4, a trihedron XYZ is shown in order to define the orientation of the various elements relative to one another. A first direction, denoted X, corresponds to a longitudinal direction of the vehicle. It also corresponds to a direction opposite to the direction of forward movement of the vehicle. A second direction, denoted Y, is a lateral or transverse direction. Finally, a third direction, denoted Z, is vertical. The directions X, Y, Z are orthogonal in pairs.

The following embodiments are examples. Although the description refers to one or more embodiments, this does not necessarily mean that each reference relates to the same embodiment, or that the features apply only to one embodiment. Individual features of different embodiments can also be combined or interchanged to provide other embodiments.

In the description, ordinal numbering can be applied to certain elements, such as first element or second element. In this case, the ordinal number is simply to differentiate and denote elements that are similar but not identical. This ordinal numbering does not imply that one element takes priority over another and such numbering can easily be interchanged without departing from the scope of the present description. Likewise, this ordinal numbering does not imply any chronological order.

In the present description, “upper” and “lower” indicate the position of an element relative to another in the direction Z determined above. An “upper” element will be closer to the roof of the vehicle, while a “lower” element will be closer to the floor.

FIG. 1 schematically shows the front part of a motor vehicle 10 with an electric or hybrid motor 12. The vehicle 10 notably comprises a body 14 and a fender 16 which are borne by a chassis (not shown) of the motor vehicle 10. The body 14 defines a cooling opening 18, that is, an opening through the body 14. In this case, there is only one cooling opening 18. This cooling opening 18 is situated in the lower part of the front end 14a of the body 14. In the example illustrated, the cooling opening 18 is situated below the fender 16. A grille 20 can be positioned in the cooling opening 18 to prevent projectiles from being able to pass through the cooling opening 18. A cooling module 22 is positioned facing the cooling opening 18. The grille 20 makes it possible in particular to protect this cooling module 22.

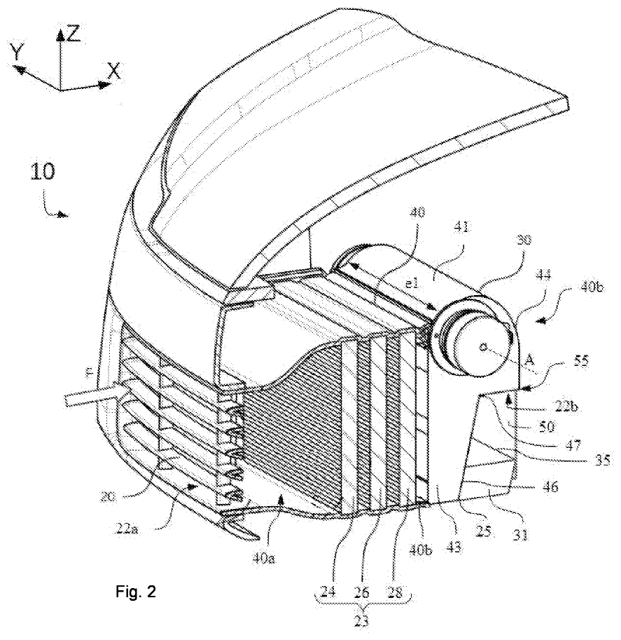

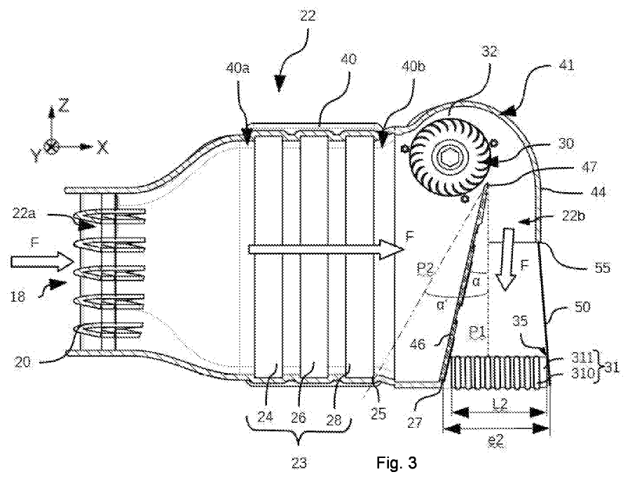

As shown in FIGS. 2 and 3, the cooling module 22 has a generally parallelepiped shape determined by a length, a width and a height. The length extends in the direction X, the width in the direction Y and the height in the direction Z.

The cooling module 22 is designed to have an air flow F passing through it parallel to the direction X, and going from the front to the rear of the vehicle 10. This direction X corresponds more particularly to the longitudinal axis of the cooling module 22. In the present application, an element which is arranged further forward or rearward than another element is referred to as “upstream” or “downstream”, respectively, in the longitudinal direction X of the cooling module. The front corresponds to the front of the motor vehicle 10 in the assembled state, or to the face of the cooling module 22 through which the air flow F is intended to enter the cooling module 22. Likewise, the rear corresponds to the rear of the motor vehicle 10, or to the face of the cooling module 22 through which the air flow F is intended to leave the cooling module 22.

The cooling module 22 essentially has a housing or fairing 40 forming an internal channel between an upstream end 40a and a downstream end 40b, which are opposite to one another. The upstream end 40a is more particularly equipped with an intake opening 22a. Inside said fairing 40 is arranged at least one heat exchanger 24, 26, 28. This internal channel is preferably oriented parallel to the direction X such that the upstream end 40a is oriented toward the front of the vehicle 10, facing the cooling opening 18, and such that the downstream end 40b is oriented toward the rear of the vehicle 10. In FIGS. 2 and 3, the cooling module 22 comprises three heat exchangers 24, 26, 28 grouped together within a set of heat exchangers 23. However, it could include more or fewer heat exchangers depending on the desired configuration.

In the example in FIGS. 2 and 3, the second heat exchanger 26 is arranged downstream of the first heat exchanger 24 while the third heat exchanger 28 is arranged downstream of the second heat exchanger 26. Other configurations can nevertheless be envisaged, such as for example the second 26 and third 28 heat exchangers both arranged upstream of the first heat exchanger 24 or on either side of the first heat exchanger 24.

In these same figures, each of the heat exchangers 24, 26, 28 has a generally parallelepiped shape that is determined by a length, a thickness and a height. The length extends along the direction Y, the thickness along the direction X and the height in the direction Z. The heat exchangers 24, 26, 28 thus extend in a general plane which is parallel to the vertical direction Z and the lateral direction Y. This general plane is preferably perpendicular to the direction of circulation of the air flow F passing through said heat exchangers 24, 26, 28 in order to maximize the heat exchange.

The cooling module 22 also includes a second housing 41 referred to as the “collector housing” in the rest of this description. This collector housing 41 is arranged downstream of the fairing 40 and of the set of heat exchangers 23 in the longitudinal direction X of the cooling module 22. More specifically, the collector housing 41 is arranged at the downstream end 40b of the fairing 40. This collector housing 41 thus makes it possible to recover the air flow F passing through the set of heat exchangers 23, and to orient this air flow F toward the discharge opening 22b. The collector housing 41 can be integral with the fairing 40 or it can be an added-on part secured to the downstream end of said fairing 40.

The cooling module 22, more specifically the collector housing 41, also comprises at least one tangential fan, also referred to as a tangential-flow turbomachine 30 configured to generate the air flow F intended to pass through the set of heat exchangers 23 from the intake opening 22a to the discharge opening 22b. The tangential-flow turbomachine 30 comprises a rotor or turbine 32 (or tangential propeller) which notably has a substantially cylindrical shape. The turbine 32 advantageously has several stages of blades (or vanes), which are visible in FIG. 3. The turbine 32 is mounted rotatably about an axis of rotation A. Advantageously, this axis of rotation A is oriented substantially parallel to the lateral direction Y. The diameter of the turbine 32 is for example between 35 mm and 200 mm so as to limit its size. The tangential-flow turbomachine 30 is thus compact.

The tangential-flow turbomachine 30 is arranged in the collector housing 41 such that the side walls 43 of the collector housing 41 are substantially perpendicular to the axis of rotation A of the turbine 32, as shown more particularly in FIG. 2. The tangential-flow turbomachine 30 is configured to draw in air so as to generate the air flow F passing through the set of heat exchangers 23. The tangential-flow turbomachine 30 comprises more specifically a blower housing 44, formed by the first collector housing 41, at the center of which the turbine 32 is arranged. The discharge opening 22b corresponds to the free end of the blower housing 44 formed by the first collector housing 41, as shown more particularly in FIG. 3.

In the example illustrated in FIGS. 2 and 3, the tangential-flow turbomachine 30 is in an upper position, in particular in the upper third of the collector housing 41, preferably in the upper quarter of the collector housing 41. This makes it possible in particular to protect the tangential-flow turbomachine 30 in the event of submersion, and/or to limit the bulk of the cooling module 22 in its lower part. In this case, the discharge opening 22b for the air flow F is preferably oriented toward the lower part of the cooling module 22.

In order to guide the air leaving the set of heat exchangers 23 toward the discharge opening 22b, the collector housing 41 comprises, facing said set of heat exchangers 23, a guide wall 46. This guide wall 46 more particularly forms the junction with an upstream edge 47 of the discharge opening 22b. In this instance, upstream edge 47 means the edge of the discharge opening 22b closest to the downstream end 40b of the fairing 40.

The guide wall 46 makes an angle α with a first plane P1 perpendicular to the longitudinal direction X of the cooling module 22; this is shown more particularly in FIG. 3. The fact that the guide wall 46 makes an angle α of between 0° and 25° allows better circulation of the air flow F within the collector housing 41 and limits the loss of pressure. Preferably, the guide wall 46 is inclined and the angle α is between 5 and 25°, preferably 23° with respect to the first plane P1. More generally, this angle α is between 0° and a maximum angle of 25°. If the angle α is 0° then the guide wall 46 coincides with the first plane P1. The maximum angle of 25° corresponds to the angle α′ of a second plane of maximum inclination P2 (visible in FIG. 3) with the first plane P1.

This second plane of maximum inclination P2 connects more specifically the upstream edge 47 of the discharge opening 22b and a downstream end edge 25 of the at least one heat exchanger 24, 26, 28. In this instance, downstream end edge 25 means the edge of a heat exchanger 24, 26, 28 closest to the downstream end 40b of the fairing 40. When the fairing 40 comprises several heat exchangers 24, 26, 28, the downstream end edge 25 taken into consideration is the downstream end edge 25 of the heat exchanger furthest downstream, in this case the third heat exchanger 28. The downstream end edge 25 is positioned facing the discharge opening 22b. This means that, as shown in FIG. 3, if the discharge opening 22b is oriented toward the lower part of the cooling module 22, the downstream end edge 25 is a lower end edge of the heat exchanger 28. Conversely, if the discharge opening 22b is oriented toward the upper part of the cooling module 22, the downstream end edge 25 will be an upper end edge of the heat exchanger 28.

As shown in FIGS. 2 and 3, the cooling module 22 further comprises an additional heat exchanger 31 intended to have the air flow F passing through it. This additional heat exchanger 31 is arranged outside the fairing 40 and the collector housing 41, downstream of the discharge opening 22b of the cooling module 22. More particularly, the additional heat exchanger 31 is located notably facing the discharge opening 22b and opposite the guide wall 46. This additional heat exchanger 31 is thus arranged in a dead volume of the cooling module 22. Advantageously, the addition of the additional heat exchanger 31 does not increase the volume taken up by the cooling module 22 within the motor vehicle 10.

According to the embodiment illustrated in FIG. 3, the additional heat exchanger 31 is arranged in a general plane parallel to the plane of the discharge opening 22b, such that the additional heat exchanger 31 is arranged perpendicularly to the air flow F discharged through the discharge opening 22b. Referring to the X, Y, Z axis system, the air flow F is intended to be discharged in a direction oriented along the direction Z and the surface for heat exchange of the additional heat exchanger 31 extends in a plane parallel to the longitudinal direction X of the cooling module 22.

In the particular case where the axis Z coincides with the vertical direction, it should be specified that the air flow F intended to be discharged through the discharge opening 22b flows vertically. The additional heat exchanger 31 is thus positioned horizontally. Thus, the orientation of the additional heat exchanger 31 located facing the discharge opening 22b of the collector housing 41 differs from that of the plurality of heat exchangers 24, 26, 28 arranged inside the housing 40 of the cooling module 22.

According to one embodiment of the additional heat exchanger 31, the latter comprises a bundle of flat tubes 310 stacked on top of one another and separated by fins 311, as shown more particularly in FIG. 3. The flat tubes 310 and the fins 311 of the additional heat exchanger 31 can be parallel to one another. The flat tubes 310 and the fins 311 are arranged perpendicularly to the general plane of the additional heat exchanger 31. Therefore, the flat tubes 310 and the fins 311 are stacked in the longitudinal direction X of the cooling module 22. In the case of the embodiment illustrated in FIG. 3, the flat tubes 310 are oriented vertically, and this makes it possible to maximize the exchange of heat between the air flow F and the additional heat exchanger 31.

In order to limit losses, the cooling module 22 can comprise at least one additional wall 50 connecting an edge 55 of the discharge opening 22b to a side of the additional heat exchanger 31, as shown in FIGS. 2 and 3.

The additional wall 50 is for example a flat and rigid plate which makes it possible to direct the air flow F discharged through the discharge opening 22b toward the additional heat exchanger 31. It can in particular be arranged on the edge 55 of the collector housing 41 to form an extension of the discharge opening 22b. The additional wall 50 is thus arranged facing the guide wall 46. According to another embodiment not illustrated in the figures, the additional wall 50 can comprise two lateral extensions reaching as far as the guide wall 46 in such a way as to form an extension duct for the discharge opening 22b. Such an extension duct makes it possible in particular to guide the air flow F discharged through the discharge opening 22b toward the additional heat exchanger 31 by limiting divergence of the air flow F such that the entire air flow F passes through the additional heat exchanger 31. This particular embodiment of the additional wall 50 also makes it possible to limit any vibration generated by the operation of the tangential-flow turbomachine 30.

The additional wall 50 can in particular take the form of a part attached to the edge 55 of the discharge opening 22b, and this makes it possible to replace this additional wall 50 more easily if necessary. In one variant, the additional wall 50 can be made in one piece with the collector housing 41, and this variant makes it possible to dispense with a connecting means between the additional wall 50 and the collector housing 41 of the cooling module 22.

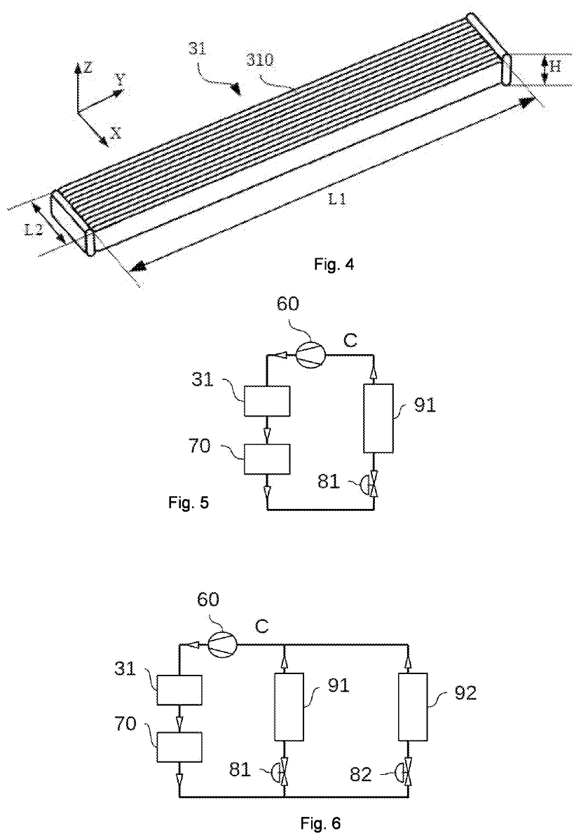

The dimensions of the additional heat exchanger 31 are intrinsically linked to the width of the cooling module 22, to the shape of the discharge opening 22b of the collector housing 41 and to the extent of the additional wall 50. According to one mode of manufacture of the additional heat exchanger 31, the latter has a parallelepiped shape comprising a length L1, a height H and a width L2, as shown more particularly in FIG. 4. The volume of the additional heat exchanger 31 can be less than the volume of one of the heat exchangers 24, 26 or 28 taken individually, as shown for example in FIGS. 2 and 3.

In particular, the length L1 of the additional heat exchanger 31 is notably less than or equal to the width of the cooling module 22. The width of the cooling module 22 can in this case designate more particularly the width of the collector housing 41. This width can in particular designate the spacing e1 between two side walls 43 of the collector housing 41. This spacing e1 is more particularly shown in FIG. 2. The width L2 of the additional heat exchanger 31 is less than or equal to a spacing e2 between the additional wall 50 and a lower edge 27 of the cooling module 22. This is more particularly shown in FIG. 3. In FIGS. 2 and 3, the additional wall 50 rests on an upper edge 35 of the additional heat exchanger 31. Such dimensions make it possible to maximize the exchange of heat between the air flow F discharged through the discharge opening 22b and the additional heat exchanger 31.

The additional heat exchanger 31 is for example arranged in a cooling circuit C such as that shown schematically in FIG. 5. Referring to the direction of circulation of the refrigerant intended to circulate within this cooling circuit C, the latter comprises a compressor 60, the additional heat exchanger 31, a condenser 70, a first expansion valve 81 and a first evaporator 91.

In the rest of this description, “positioned upstream” means that an element is positioned before another with respect to the direction in which the refrigerant circulates. By contrast, “placed downstream” means that an element is placed after another with respect to the direction in which the refrigerant circulates.

The additional heat exchanger 31 is therefore located downstream of the compressor 60 and upstream of the condenser 70. Thus positioned, the additional heat exchanger 31 serves as a desuperheater, that is to say that it lowers the temperature of the refrigerant coming from the compressor 60 before it enters the condenser 70. The additional heat exchanger 31 thus makes it possible to optimize the efficiency of the condenser 70 by supplying it with a refrigerant the temperature of which is very close to saturation. The additional heat exchanger 31 can for example be connected to the air conditioning circuit.

According to a first embodiment of the cooling circuit C, the first evaporator 91 is a thermal management interface configured to exchange heat with the batteries of the motor vehicle Specifically, in order for these batteries to be as efficient as possible they need to remain at an optimal operating temperature. It is therefore necessary to cool them during use to ensure that they do not excessively exceed this optimal operating temperature. Likewise, it can also be necessary to heat these batteries, for example in cold weather, so that they reach this optimal operating temperature in the shortest possible time.

In one variant of the cooling circuit C shown in FIG. 6, said circuit C comprises a second expansion valve 82 and a second evaporator 92 which are for example arranged in parallel with the first expansion valve 81 and the first evaporator 91. The second evaporator 92 is for example intended to have an internal air flow passing through it, and it is in particular configured to cool an air flow intended for the passenger compartment of the motor vehicle 10. Thus, the second evaporator 92 can in particular participate in the air conditioning of the motor vehicle 10.

The invention is not limited to the exemplary embodiments described with reference to the figures, and further embodiments will be clearly apparent to a person skilled in the art. In particular, the various examples can be combined, provided they are not contradictory.

What is claimed is:

1. A cooling module for a motor vehicle with an electric or hybrid motor, comprising:
at least one heat exchanger;
at least one tangential-flow turbomachine having an axis of rotation, the at least one tangential-flow turbomachine being capable of creating an air flow circulating between an intake opening and a discharge opening, passing through the at least one heat exchanger;
at least one housing configured to house the at least one heat exchanger and said at least one tangential-flow turbomachine, the intake opening and the discharge opening being part of the at least one housing; and
an additional heat exchanger through which the air flow is intended to pass, arranged outside the at least one housing, downstream of the discharge opening of the cooling module in a longitudinal direction of the cooling module.

2. (canceled)

3. (canceled)

4. (canceled)

5. The cooling module as claimed in claim 1, wherein the additional heat exchanger has a parallelepiped shape including a length, a height and a width and in that the length of the additional heat exchanger is less than or equal to a width of the cooling module.

6. The cooling module as claimed in claim 1, further comprising at least one additional wall connecting an edge of the discharge opening to a side of the additional heat exchanger.

7. The cooling module as claimed in claim 6, wherein the at least one additional wall is a part attached to the edge of the discharge opening.

8. The cooling module as claimed in claim 6, wherein the additional heat exchanger has a parallelepiped shape having a length, a height and a width and in that the width of the additional heat exchanger is less than or equal to a spacing between the at least one additional wall and a lower edge of the cooling module.

9. The cooling module as claimed in claim 1, wherein the additional heat exchanger is positioned in a general plane parallel a longitudinal direction of the cooling module.

10. The cooling module as claimed in claim 1, wherein the additional heat exchanger is positioned in a general plane parallel to a plane of the discharge opening.

11. A cooling circuit for a motor vehicle with an electric or hybrid motor, comprising:
a compressor;
a condenser connected in-series downstream of the compressor;
a first expansion valve connected in-series downstream of the condenser; and
a first evaporator connected in-series downstream of the first expansion valve;
a cooling module, including:
at least one heat exchanger;
at least one tangential-flow turbomachine having an axis of rotation, the at least one tangential-flow turbomachine being capable of creating an air flow circulating between an intake opening and a discharge opening, passing through the at least one heat exchanger;
at least one housing configured to house the at least one heat exchanger and said at least one tangential-flow turbomachine, the intake housing and the discharge housing being part of the at least one housing; and
an additional heat exchanger through which the air flow is intended to pass, arranged outside the at least one housing, downstream of the discharge opening of the cooling module in a longitudinal direction of the cooling module, with the additional heat exchanger being connected in-series downstream of the compressor and upstream of the condenser.

12. The cooling circuit as claimed in claim 11, wherein the first evaporator of the cooling circuit is a thermal management interface configured to exchange heat with batteries of the motor vehicle.

13. The cooling circuit as claimed in claim 11, wherein the cooling circuit further comprises a second expansion valve and a second evaporator arranged in parallel with the first expansion valve and the first evaporator, and in that the second evaporator is intended to have an internal air flow passing through it.
